(19) United States
(12) Patent Application Publication
(10) Pub. No.: US 2013/0051355 A1
(43) Pub. Date: Feb. 28, 2013

(54) APPARATUS AND METHOD FOR TRANSMITTING CONTROL INFORMATION IN A MULTI-COMPONENT CARRIER SYSTEM

(71) Applicant: Sung Kwon Hong, Seoul (KR)

(72) Inventor: Sung Kwon Hong, Seoul (KR)

(73) Assignee: PANTECH CO., LTD., Seoul (KR)

(21) Appl. No.: 13/696,012

(22) PCT Filed: May 3, 2011
(86) PCT No.: PCT/KR2011/003289

§ 371 Date: Nov. 2, 2012

(30) Foreign Application Priority Data
May 3, 2010 (KR) 10-2010-0041607

(51) Int. Cl. H04W 72/04

(52) U.S. Cl. 370/329

(57) ABSTRACT

A method for transmitting control information in a multi-component carrier system comprises: configuring downlink control information containing a format indicator that indicates the number of Orthogonal Frequency Division Multiplexing (OFDM) symbols for a control domain; configuring the control domain in accordance with the number of OFDM symbols; transmitting a physical downlink control channel (PDCCH) containing the thus-configured downlink control information; and transmitting a physical control format indicator channel, containing the format indicator, to the control domain. According to the exemplary embodiments, multiple errors in detecting a PDCCH and a physical downlink shared channel (PDSCH) caused by an error in detecting a physical control format indicator channel (PCFICH) for a sub-component carrier can be easily resolved.

### BACKGROUND

1. Field

The present invention relates to wireless communication and, more specifically, to an apparatus and method for transmitting control information indicative of the format of a control channel in a multi-component carrier system.

2. Discussion of the Background

As the candidates of the next-generation wireless communication system, 3rd Generation Partnership Project (3GPP) Long Term Evolution (LTE) and Institute of Electrical and Electronics Engineers (IEEE) 802.16m are being developed. The 802.16m standard involves two aspects that are the past continuity of the modification of the existing 802.16e standard and the future continuity of a standard for the next-generation IMT-Advanced system. Accordingly, the 802.16m standard is required to maintain compatibility with a mobile WiMAX system based on the 802.16e standard and also satisfy all advanced requirements for the IMT-Advanced system.

In general, a wireless communication system uses one bandwidth in order to transmit data. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increased transmission capacity, the bandwidth of a recent 3GPP LTE or IEEE 802.16m extends up to 20 MHz or higher. To increase the bandwidth in order to increase the transmission capacity may be considered to be essential, but to support a great bandwidth even when the quality of service required is low may cause great power consumption.

A multiple component carrier system is a system in which a carrier having one bandwidth and the center frequency is defined and data can be transmitted and/or received in a broad band formed by aggregating a plurality of carriers. A narrow band and a broad band are supported at the same time by using one or more carriers. For example, if one carrier corresponds to a bandwidth of 5 MHz, a maximum 20 MHz bandwidth is supported by using four carriers.

In a multiple component carrier system, a component carrier on which both control information and data are transmitted and a component carrier on which data except control information is transmitted may be differently operated. In this process, if control information on a component carrier on which data is chiefly transmitted is not transmitted because an error occurs in the control information, there is a problem in that the entire data information that can be accessed through the control information may not be used. Accordingly, it is necessary to increase the usability of data included in a component carrier.

### SUMMARY

An object of the present invention is to provide an apparatus and method for transmitting control information indicative of the format of a control channel in a multi-component carrier system.

In accordance with an aspect of the present invention, there is provided a method of a base station transmitting control information in a multi-component carrier system in which a primary component carrier and a secondary component carrier are aggregated. The method of transmitting control information includes the steps of configuring downlink control information (DL grant) including a format indicator indicative of the number of Orthogonal Frequency Division Multiplexing (OFDM) symbols for a control region, configuring the control region according to the number of OFDM symbols, transmitting a physical downlink control channel (hereinafter referred to as a PDCCH) including the configured downlink control information, and transmitting a physical control format indicator channel (hereinafter referred to as a PCFICH), including the format indicator, on the control region.

In accordance with another aspect of the present invention, there is provided a method of a user equipment receiving control information in a multi-component carrier system in which a primary component carrier and a secondary component carrier are aggregated. The method of receiving control information includes the steps of receiving first downlink control information, including a format indicator indicative of the number of OFDM symbols that form a control region, from a base station through a first PDCCH and transmitting uplink control information to the base station through a physical uplink control channel (PUCCH).

In accordance with yet another aspect of the present invention, there is provided an apparatus for receiving control information in a multi-component carrier system in which a primary component carrier and a secondary component carrier are aggregated. The apparatus for receiving control information includes a control information reception unit for receiving first downlink control information, including a format indicator indicative of the number of OFDM symbols for a control region, through a first PDCCH and receiving second downlink control information, including a power indicator for controlling the transmit power of an uplink control channel, through a second PDCCH, a control channel decoding unit for decoding a PCFICH and a physical downlink shared channel (PDSCH) indicated by the first PDCCH based on the format indicator, and an uplink transmission unit for controlling the transmit power of a uplink control channel regarding the PDSCH based on the power indicator and transmitting the uplink control channel.

In accordance with further yet another aspect of the present invention, there is provided an apparatus for transmitting control information in a multi-component carrier system in which a primary component carrier and a secondary component carrier are aggregated. The apparatus for transmitting control information includes a control information configuration unit for configuring first downlink control information, including a format indicator indicative of the number of OFDM symbols for a control region, and second downlink control information including a power indicator for controlling the transmit power of an uplink control channel, a control information transmission unit for transmitting the first downlink control information through a first PDCCH and transmitting the second downlink control information through a second PDCCH, and an uplink reception unit for receiving an uplink control channel transmitted with transmit power based on the power indicator related to a PDSCH indicated by the first PDCCH.

When a format indicator regarding a secondary component carrier is transmitted through a primary component carrier, a UE can know the PDCCH format of the secondary component carrier and frequently detected errors in a PDCCH and a PDSCH due to an error detected in the PCFICH of the secondary component carrier can be easily solved.

### BRIEF DESCRIPTION OF THE DRAWINGS

FIG. 1 shows a wireless communication system.

FIG. 2 shows an example of a protocol structure for supporting multiple carriers.

FIG. 3 shows an example of a frame structure for a multi-carrier operation.

FIG. 4 shows linkage between downlink component carriers and uplink component carriers in a multi-carrier system.

FIG. 5 is an explanatory diagram illustrating a method of transmitting downlink control information in a multi-component carrier system in accordance with an example of the present invention.

FIG. 6 is an explanatory diagram illustrating a method of transmitting downlink control information in a multi-component carrier system in accordance with another example of the present invention.

FIG. 7 is a flowchart illustrating a method of transmitting control information in a multi-component carrier system in accordance with an example of the present invention.

FIG. 8 is a flowchart illustrating a method of transmitting control information in a multi-component carrier system in accordance with another example of the present invention.

FIG. 9 is a flowchart illustrating a method of transmitting control information in a multi-component carrier system in accordance with an example of the present invention.

FIG. 10 is a block diagram illustrating an apparatus for transmitting and receiving control information in a multi-component carrier system in accordance with an example of the present invention.

### DETAILED DESCRIPTION OF THE ILLUSTRATED EMBODIMENTS

Hereinafter, in this specification, some embodiments are described in detail with reference to exemplary drawings. It is to be noted that in assigning reference numerals to elements in each of the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

Furthermore, in describing the elements of this specification, terms, such as the first, second, A, B, a, and b, may be used. However, the terms are used to only distinguish one element from the other element, but the essence, order, or sequence of the elements is not limited by the terms.

Furthermore, in this specification, a wireless communication network is described as a target, and tasks performed in the wireless communication network may be performed in a process in which a system (e.g., a base station) managing the wireless communication network controls the wireless communication network and sends data or may be performed in a terminal accessing the wireless communication network.

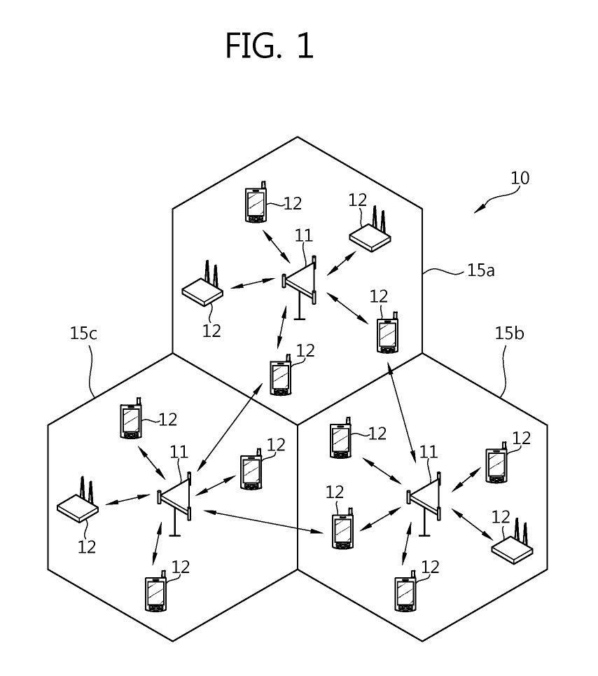

FIG. 1 shows a wireless communication system.

Referring to FIG. 1, the wireless communication systems 10 are widely deployed in order to provide a variety of communication services, such as voice and packet data. The wireless communication system 10 includes one or more Base Stations (BS) 11. The BSs 11 provide communication services to specific geographical areas (commonly called cells) 15a, 15b, and 15c. Each of the cells may be classified into a plurality of areas (called sectors).

A User Equipment (UE) 12 may be fixed or mobile and may be also called another terminology, such as Mobile Station (MS), a Mobile Terminal (MT), a User Terminal (UT), a Subscriber Station (SS), a wireless device, a Personal Digital Assistant (PDA), a wireless modem, or a handheld device. The BS 11 refers to a fixed station communicating with the UEs 12, and it may also be called another terminology, such as an evolved NodeB (eNB), a Base Transceiver System (BTS), or an access point. Each of the cells 15a, 15b, and 15c should be interpreted as a comprehensive meaning that indicates some area covered by the BS 11. The cell has a meaning to cover various coverage areas, such as a mega cell, a macro cell, a micro cell, a pico cell, and a femto cell.

Hereinafter, downlink refers to communication from the BS 11 to the UE 12, and uplink refers to communication from the UE 12 to the BS 11. In downlink, a transmitter may be part of the BS 11, and a receiver may be part of the UE 12. In uplink, a transmitter may be part of the UE 12, and a receiver may be part of the BS 11. Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), OFDM-FDMA, OFDM-TDMA, and OFDM-CDMA, may be used. Uplink transmission and downlink transmission may be performed in accordance with a Time Division Duplex (TDD) scheme using different times or a Frequency Division Duplex (FDD) scheme using different frequencies.

A carrier aggregation (CA) supports a plurality of component carriers. The carrier aggregation is also called a spectrum aggregation or a bandwidth aggregation. An individual unit carrier aggregated by the carrier aggregation is called a Component Carrier (CC). Each of the CCs is defined by a bandwidth and the center frequency. The carrier aggregation is introduced to support an increased throughput, prevent an increase of costs due to the introduction of wideband Radio Frequency (RF) devices, and guarantee compatibility with the existing system. For example, if five CCs are allocated as the granularity of a carrier unit having a 5 MHz bandwidth, a maximum bandwidth of 25 MHz can be supported.

A CA may be divided into a contiguous CA that is performed between contiguous component carriers and a non-contiguous CA that is performed between non-contiguous component carriers in the frequency domain. The number of aggregated carriers may be differently set between downlink and uplink. A case where the number of downlink component carriers is equal to the number of uplink component carriers is called a symmetric aggregation, and a case where the number of downlink component carriers is different from the number of uplink component carriers is called an asymmetric aggregation.

Component carriers may have different sizes (i.e., bandwidths). For example, assuming that 5 component carriers are used to form a 70 MHz band, a resulting configuration may be, for example, 5 MHz component carrier (carrier #0)+20 MHz component carrier (carrier #1)+20 MHz component carrier (carrier #2)+20 MHz component carrier (carrier #3)+5 MHz component carrier (carrier #4).

Hereinafter, a multiple component carrier system refers to a system that supports a CA. In a multiple component carrier system, a contiguous CA and/or a non-contiguous CA may be used, and a symmetric aggregation or an asymmetric aggregation may be used.

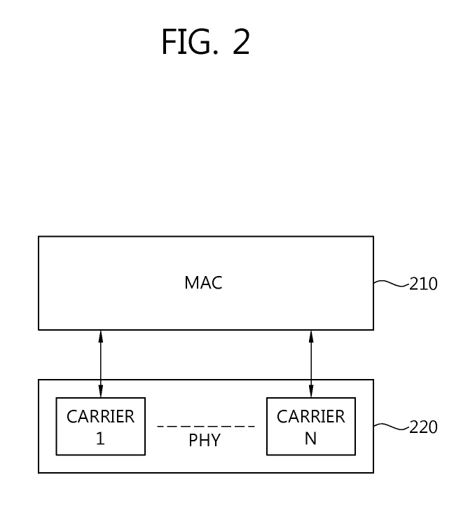

FIG. 2 shows an example of a protocol structure for supporting multiple carriers.

Referring to FIG. 2, a common Medium Access Control (MAC) entity 210 manages a physical layer 220 using a plurality of carriers. An MAC management message that is transmitted through a specific carrier can be applied to other carriers. That is, the MAC management message is a message that can control other carriers including the specific carrier. The physical layer 220 can be operated in accordance with a Time Division Duplex (TDD) method and/or a Frequency Division Duplex (FDD) method.

Several physical control channels are used in the physical layer 220. A physical downlink control channel (PDCCH) informs a UE of the resource allocation of a paging channel (PCH) and a downlink shared channel (DL-SCH) and Hybrid Automatic Repeat Request (HARQ) information related to a DL-SCH. The PDCCH can carry an uplink grant that informs a UE of uplink resource allocation and a downlink grant that informs a UE of the resource allocation of downlink transmission. A physical control format indicator channel (PCFICH) is a physical channel that sends the format of all control channels, that is, a format indicator that indicates the number of OFDM symbols that form all control channels, to a UE. The PCFICH is transmitted for every frame. The format indicator may be also called a Control Format Indicator (CFI).

A physical hybrid ARQ indicator channel (PHICH) carries HARQ ACK/NAK signals in response to uplink transmission and belongs to a downlink control channel along with a PCFICH and a PDCCH. A physical uplink control channel (PUCCH) carries HARQ ACK/NAK for downlink transmission, a scheduling request, a Sound Reference Signal (SRS), and uplink control information, such as a Channel Quality Indicator (CQI). A physical uplink shared channel (PUSCH) can carry UCI information, such as an uplink shared channel (UL-SCH) and an aperiodic CQI.

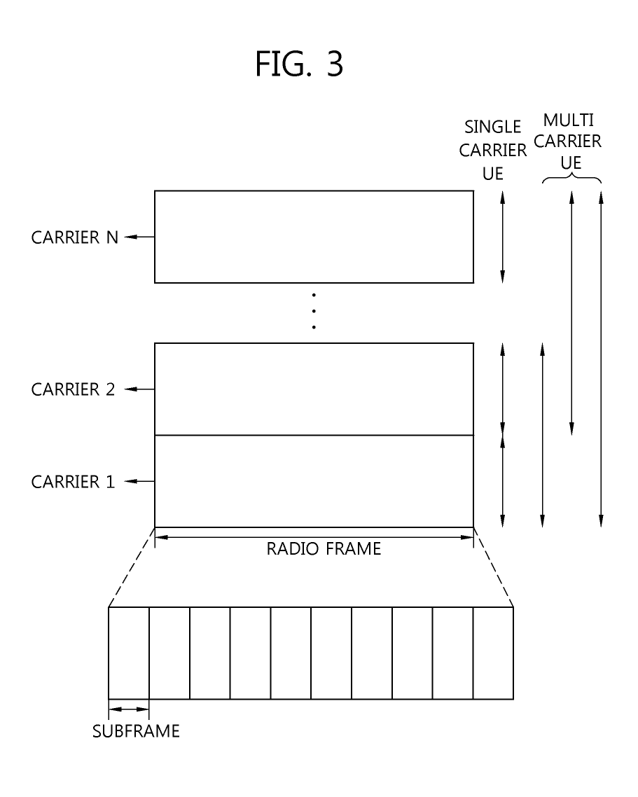

FIG. 3 shows an example of a frame structure for a multi-carrier operation to which the present invention is applied.

Referring to FIG. 3, a frame includes 10 subframes. The subframe includes a plurality of OFDM symbols. Each carrier may have its own control channel (e.g., a PDCCH). Multiple carriers may be contiguous to each other or may not be contiguous to each other. A UE can support one or more carriers depending on the capability of the UE.

A component carrier may be divided into a fully configured carrier and a partially configured carrier depending on it directivity. The fully configured carrier is a bidirectional carrier, and it refers to a carrier which can transmit and/or receive all control signals and data. The partially configured carrier is a unidirectional carrier, and it refers to a carrier which can transmit only downlink data. The partially configured carrier may be chiefly used in Multicast and Broadcast Service (MBS) and/or a Single Frequency Network (SFN).

A component carrier may be divided into a Primary Component Carrier (PCC) and a Secondary Component Carrier (SCC) depending on whether it has been activated. The PCC is a carrier that is always activated, and the SCC is a carrier that is activated or deactivated depending on a specific condition. Activation refers to a state in which the transmission or reception of traffic data is being performed or a state in which the transmission or reception of traffic data is in a ready state. Deactivation refers to a state in which the transmission or reception of traffic data is impossible, but measurement or the transmission/reception of minimum information is possible. A UE may use only one PCC or may use one or more SCCs is along with a PCC. A BS may allocate a PCC and/or an SCC to a UE. A PCC may be a fully configured carrier and is a carrier in which pieces of major control information are exchanged between a BS and a UE. An SCC may be a fully configured carrier or a partially configured carrier and is a carrier that is allocated at the request of a UE or according to an instruction of a BS. A PCC may be used for the entry of a UE into a network and/or for the allocation of an SCC. A PCC is not fixed to a specific carrier, but may be selected from fully configured carriers. A carrier configured as an SCC may be also changed into a PCC.

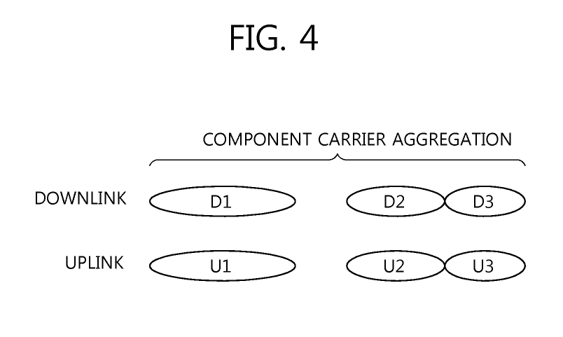

FIG. 4 shows linkage between downlink component carriers and uplink component carriers in a multi-carrier system to which the present invention is applied.

Referring to FIG. 4, in downlink, downlink component carriers D1, D2, and D2 are aggregated and in uplink, uplink component carriers U1, U2, and U3 are aggregated. Here, Di is the index of the downlink component carrier, and U1 is the index of the uplink component carrier (i=1, 2, 3). At least one downlink component carrier is a PCC, and the remaining component carriers are SCCs. Likewise, at least one uplink component carrier is a PCC, and the remaining component carriers are SCCs. For example, D1 and U1 are PCCs, and D2, U2, D3, and U3 are SCC.

A downlink component carrier and an uplink component carrier may be linked to each other in a one-to-one manner. D1 is linked to U1, D2 is linked to U2, and D3 is linked to U3 in a one-to-one manner. A UE establishes linkage between downlink component carriers and uplink component carriers through system information transmitted by a logical channel BCCH or an RRC message dedicated to a UE which is transmitted by a DCCH. Each linkage may be set up in a cell-specific manner or a UE-specific manner.

A primary serving cell (PCell) means one serving cell that provides security input and NAS mobility information in an RRC establishment or re-establishment state. At least one cell may be configured to form a set of serving cells along with a PCell depending on the capabilities of a UE. The at least one cell is called a secondary serving cell (SCell).

Accordingly, a set of serving cells configured to one UE may include only one PCell or one PCell and at least one SCell.

A downlink component carrier corresponding to a PCell is called a downlink PCC (DL PCC), and an uplink component carrier corresponding to a PCell is called an uplink PCC (UL PCC). Furthermore, in downlink, a CC corresponding to an SCell is called a downlink SCC (DL SCC) and in uplink, a CC corresponding to an SCell is called an uplink SCC (UL SCC). Only one DL CC can correspond to one serving cell, and both a DL CC and an UL CC may correspond to one serving cell.

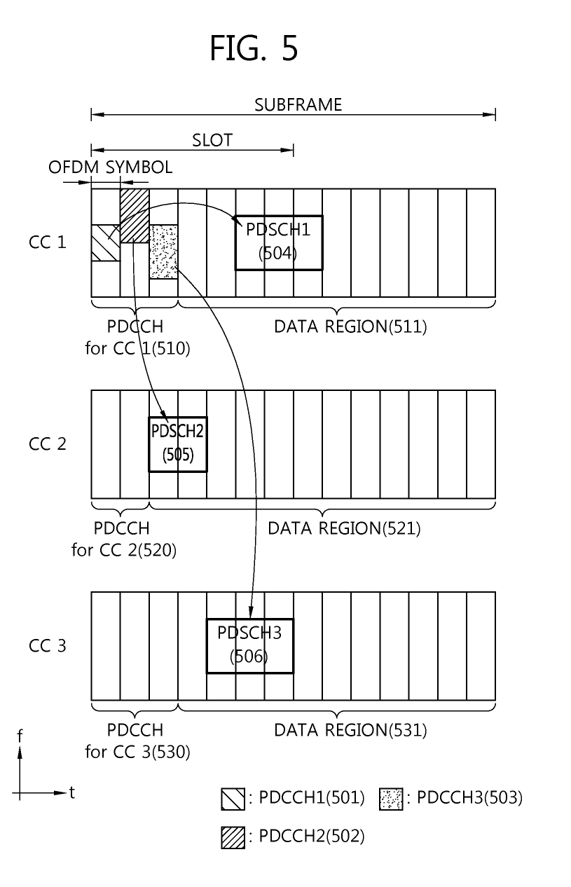

FIG. 5 is an explanatory diagram illustrating a method of transmitting downlink control information in a multi-component carrier system in accordance with an example of the present invention.

Referring to FIG. 5, a multi-component carrier system provide three component carriers, that is, a first component carrier CC1, a second component carrier CC2, a third component carrier CC3 to a UE through a CA. From among them, any one carrier is a PCC, and the remaining carriers are SCCs. It is assumed that the CC1 is a PCC, for convenience of description.

The downlink subframe of each component carrier basically includes a control region including at least one PDCCH and a data region including at least one PDSCH. The CC1 includes a PDCCH for the CC1 510 and a data region 511, the CC2 includes a PDCCH for the CC2 520 and a data region 521, and the CC3 includes a PDCCH for the CC3 530 and a data is region 531. Here, the number of OFDM symbols that form the PDCCH is variable. For example, the number of OFDM symbols for each of the PDCCH 510 of the CC1 and the PDCCH 530 of the CC3 is 3, and the number of OFDM symbols for the PDCCH 520 of the CC2 is 2. As described above, information indicative of the number of OFDM symbols for the PDCCH of each CC is called a format indicator. The format indicator is transmitted by signaling in a PCFICH, a PDCCH, or a higher layer level, such as a Medium Access Control (MAC) or Radio Resource Control (RRC) layer.

Each component carrier may include a plurality of PDCCHs. For example, the PDCCH 510 for the CC1 includes a PDCCH1 501, a PDCCH2 502, and a PDCCH3 503. A UE can monitor the plurality of PDCCHs. That is, a UE monitors the plurality of PDCCHs in accordance with a blind decoding method using a specific Radio Network Temporary Identifier (RNT) that has been allocated thereto. Control information transmitted through the PDCCH is called Downlink Control Information (hereinafter referred to as DCI). The DCI is differently used depending on its format, and it also has a different field that is defined within the DCI. Table 1 shows DCI according to a DCI format.

TABLE 1

| DCI format | Description |
|---|---|
| 0 | Used for the scheduling of a PUSCH (uplink grant) |
| 1 | Used for the scheduling of one PDSCH codeword |
| 1A | Used for the simplified scheduling of one PDSCH |
| | codeword and for a random access procedure reset |
| | by a PDCCH command |
| 1B | Used for the simplified scheduling of one PDSCH |
| | codeword using precoding information |
| 1C | Used for the simplified scheduling of one PDSCH |
| | codeword and the notification of a change of an MCCH |
| 1D | Used for precoding and the simplified scheduling of one |
| | PDSCH codeword including power offset information |
| 2 | Used for PDSCH scheduling for a UE configured in spatial |
| | multiplexing mode |
| 2A | Used for the PDSCH scheduling of a UE configured in |
| | large delay CDD mode |
| 3 | Used for the transmission of a TPC command for a |
| | PUCCH and PUSCH including 2-bit power coordination |
| 3A | Used for the transmission of a TPC command for a PUCCH |
| | and PUSCH including single bit power coordination |

Referring to Table 1, the DCI format 0 indicates uplink resource allocation information, the DCI formats 1˜2 indicate downlink resource allocation information, and the DCI formats 3 and 3A indicate uplink Transmit Power Control (TPC) commands for specific UE groups. The fields of the DCI are sequentially mapped to an information bit. For example, assuming that DCI is mapped to an information bit having a length of a total of 44 bits, a resource allocation field may be mapped to a 10^{th} bit 23^{rd} bit of the information bit. DCI used in the scheduling of an uplink channel is called an uplink grant, and DCI used in the scheduling of a downlink channel is called a downlink grant.

Each of the PDCCH1 501, the PDCCH2 502, and the PDCCH3 503 transmits DCI having any one of the DCI formats 1/1A/1B/1C/1D/2/2A. Accordingly, the resource allocation field included in the DCI format indicates a PDSCH of a specific component carrier. For example, the DCI of the PDCCH1 501 indicates the PDSCH1 504 of a CC1, the DCI of the PDCCH2 502 indicates the PDSCH2 505 of a CC2, and the DCI of the PDCCH3 503 indicates the PDSCH3 506 of a CC3. As described above, in a CA, DCI information on a PDCCH can transmit not only resource allocation within a carrier to which the PDCCH belongs, but also allocation information on other carrier resources. This is called cross-carrier scheduling. In the cross-carrier scheduling, scheduling becomes flexible because control information on an SCC is transmitted through a PCC, but there is a high probability that an error in the detection of the physical channel of an SCC may be high.

For example, if resource allocation indicated by a PCFICH and a PDCCH is performed within one carrier, the error rate of the PCFICH tends to be lower than the error rate of the PDCCH. Accordingly, within the same one carrier, resource allocation is rarely made wrong by an error of a PCFICH and an error of a PDSCH is rarely caused. In the case of cross-carrier scheduling, however, if the channel condition of the CC2 is deteriorated and thus an error of the PCFICH of the CC2 is severely generated, it directly generates an error of the PDSCH2 505 that is allocated by the PDCCH2 502 of the CC1. This error of the PCFICH is generated even when there is no error in the PDCCH1 501 of the CC1, and an error of the PDSCH2 505 caused by this error induces HARQ retransmission in the CC2, thereby resulting in additional resource consumption.

If a format indicator regarding an SCC is transmitted through a PCC, a UE can know a PDCCH format of the SCC and the frequently detected errors of a PDCCH and a PDSCH due to the detected error of the PCFICH of the SCC can be easily solved. A method of transmitting a format indicator regarding an SCC through a PCC is described below.

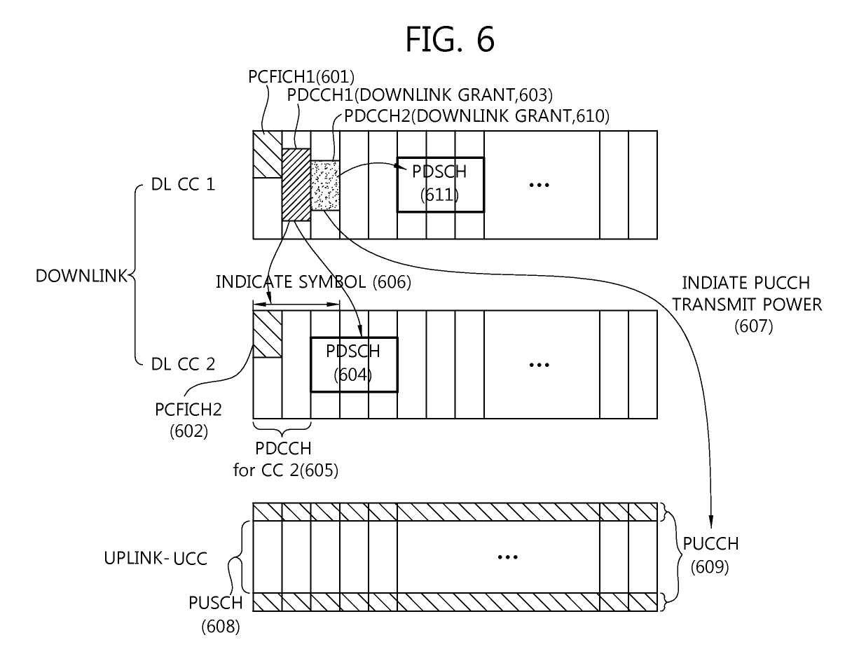

In general, a DCI format indicative of a downlink grant includes a power indicator field of 2 bits for power control over a PUCCH, and a DCI format indicative of an uplink grant includes a power indicator field of 2 bits for power control over a PUSCH. The power indicator may also be called Transmitter Power Control (TPC). Furthermore, in a multi-component carrier system, a downlink grant regarding one or more CCs can be transmitted. All one or more downlink grants transmit a power indicator for the PUCCH of one uplink component carrier that is linked to a downlink component carrier. In this case, the same one or more power indicators for power control over the same uplink PUCCH are transmitted. This acts on overhead to downlink control information. Accordingly, in the case where there is a plurality of power indicators for one PUCCH due to the transmission of a plurality of downlink grants, if a redundant power indicator field is replaced with a format indicator indicative of a PDCCH format of another component carrier, problems due to an error detected in the PCFICH of another component carrier can be solved and resources can be efficiently used. This is described in detail with reference to FIG. 6.

FIG. 6 is an explanatory diagram illustrating a method of transmitting downlink control information in a multi-component carrier system in accordance with another example of the present invention.

Referring to FIG. 6, a DL CC1 and a DL CC2 are downlink component carriers, the DL CC1 is a PCC, and the DL CC2 is an SCC. This is only for convenience of description. The DL CC2 may become a PCC, and the DL CC1 may become an SCC. Furthermore, the SCC may be one or more. The number of OFDM symbols for the PDCCH of the DL CC1 is 3: a PCFICH 601, a PDCCH1 (DL grant, 603), and a PDCCH2 (DL grant, 610). The data region of the DL CC1 starts from a fourth OFDM symbol and includes a PDSCH 611. The number of OFDM symbols for the PDCCH of the DL CC2 is 2, which includes a PCFICH 602. Furthermore, the data region of the DL CC2 includes a PDSCH 604. An UCC is an uplink component carrier and linked to the DL CC1. The UCC includes a PUCCH 609 and a PUSCH 608.

One of the DCI formats of two PDCCHs of the DL CC1 includes a format indicator regarding the DL CC2 (606), the other thereof includes a power indicator indicative of transmit power for the PUCCH 609 of the UCC (607). For example, the DCI of the PDCCH1 603 includes allocation information on the PDSCH 604 of the DL CC2 and the format indicator of the DL CC2 (606), and the DCI of the PDCCH2 610 includes allocation information on the PDSCH 611 of the DL CC1 and the power indicator of the PUCCH 609 regarding the UCC (607). Here, since the DCI of the PDCCH2 610 includes allocation information on the PDSCH 611 of the DL CC1, the PDCCH2 610 relates to a primary component downlink carrier. Thus, the power indicator can be said that is it transmitted through a PDCCH related to the primary component downlink carrier. Furthermore, this power indicator controls the control channel of a primary component uplink carrier that is linked to the primary component downlink carrier. In contrast, the DCI of the PDCCH1 603 relates to a secondary component downlink carrier and includes allocation information on the PDSCH 604 of the DL CC2 and a format indicator regarding the secondary component downlink carrier.

If there is an additional SCC in addition to the DL CC2, the DL CC1 may include an additional PDCCH and the DCI of the additional PDCCH may include the format indicator of the additional SCC. That is, one PCC can transmit a format indicator regarding a plurality of SCCs.

The format indicator regarding the SCC must be suitable for the structure of the existing power indicator field that is unnecessarily redundant because the existing power indicator field is utilized for a format indicator. The format indicator can be properly mapped to the power indicator field as in Table 2 because it commonly has information of 2 bits and can indicate a different value depending on the number of Resource Block Groups (hereinafter referred to as RBGs).

TABLE 2

| format indicator | | power indicator | | |
|---|---|---|---|---|
| Number of | Number of | Embodiment | Embodiment | |
| RBGs≦10 | RBGs>10 | 1 | 2 | Embodiment 3 |
| 2 | 1 | 00 | 01 | Convert the number |
| 3 | 2 | 01 | 10 | of format indicators |
| 4 | 3 | 10 | 11 | into a binary |
| | | | | number |

Referring to Table 2, the format indicator has any one of 2, 3, and 4 if the number of RBGs given according to a bandwidth is 10 or less and has any one of 1, 2, and 3 if the number of RBGs exceeds 10. Accordingly, the power indicator has any one value of 00, 01, 10, and 11, which is given as in embodiments 1, 2, and 3. A total of 4 types of cases can be represented because the format indicator has 2-bit information. Since the format indicator requires only three cases, the remaining one case may be used as another control information.

Table 3 is an example of DCI regarding a downlink grant.

```
TABLE 3
- Resource allocation header (resource allocation type 0/type 1) - 1 bit. If a
downlink bandwidth is smaller than or equal to 10 PRB, there is no
resource allocation header, and it is considered as a resource allocation
type 0.
  - Resource block allocation:
- Resource allocation type 0
- A |N_{RB}^{DL}/P| bit provides resource allocation
- Resource allocation type 1
  - A ┌log₂(P)┐ bit is used as a header specific to a resource allocation
type 0 that indicates a selected resource block subset.
  - 1 bit indicates a shift of a resource allocation span.
  - (|N_{RB}^{DL}/P|−┌log₂(P)┐−1) bits provide resource allocation.
P depends on the number of downlink resource blocks.
- Modulation and coding scheme - 5 bits
- HARQ processor number - 3 bits (FDD), 4 bits (TDD)
- New data indicator - 1 bit
- Redundancy version - 2 bits
- Control format indicator for the PDCCH of an SCC or a TPC command
for a scheduled PUCCH - 2 bits
- Carrier indicator (CI) - 3 bits, indicates the index of a CC.
- Downlink allocation index - 2 bits, it exists in all uplink-downlink
configurations in TDD, it is applied to only TDD operations in uplink-
downlink configurations 1-6, and it does not exist in FDD.
```

Referring to Table 3, this is similar to the structure of another common downlink grant. CFI is information indicative of the number of OFDM symbols of the PDCCH of an SCC, and it includes 2 bits. A power indicator TPC and a format indicator CIF use the same fields exclusively according to circumstances. A Carrier Indicator (CI) may indicate a different thing depending on whether a corresponding field is used as a power indicator or a format indicator. The carrier indicator indicates a component carrier and has 3 bits. A UE can know whether a corresponding downlink grant is related to what component carrier using the carrier indicator. For example, if a field is used as a power indicator, the carrier indicator of a corresponding downlink grant indicates a PCC. If the field is used as a format indicator, the carrier indicator of the corresponding downlink grant indicates an SCC. In other words, when a carrier indicator indicates an SCC, a field is used as a format indicator. When the carrier indicator indicates a PCC, the field is used as a power indicator.

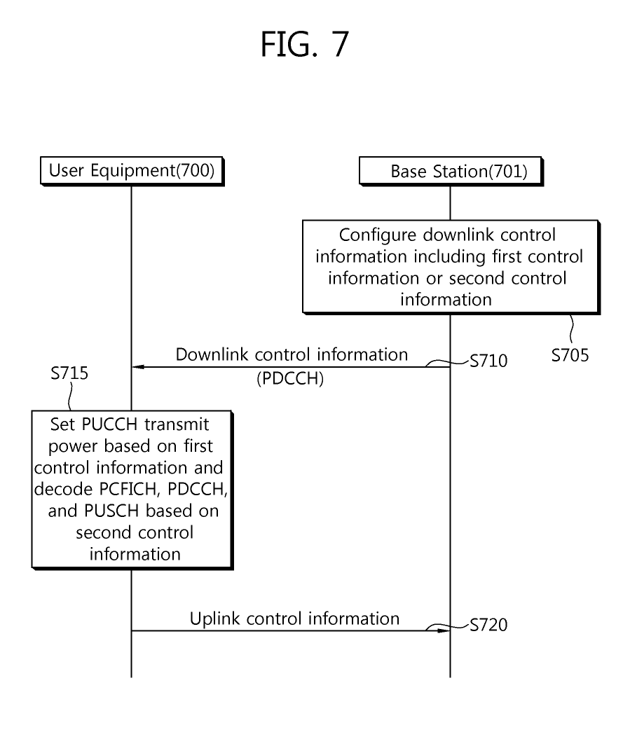

FIG. 7 is a flowchart illustrating a method of transmitting control information in a multi-component carrier system in accordance with an example of the present invention.

Referring to FIG. 7, a BS 701 configures first downlink control information including a power indicator and second downlink control information including a format indicator (S705). The power indicator indicates the transmit power of an uplink control channel, and the format indicator indicates the format of the control region of a secondary component downlink carrier. For example, the format indicator indicates the number of OFDM symbols for the PDCCH of the secondary component downlink carrier.

The power indicator and the format indicator have the same length of an information bit and can have the same format. This is only an example, and the lengths of the information bits and the formats, of the power indicators and the format indicators, may be different.

Each of the pieces of first and the second downlink control information is any one of the DCI formats 1, 1A, 1B, 1C, 1D, 2, and 2A and can be called a downlink grant. The first downlink control information can further include resource allocation information on the PDSCH1, and the second downlink control information can further include resource allocation information on the PDSCH2. Furthermore, each of the pieces of first and the second downlink control information can further include a Carrier Indicator (CI) indicative of a component carrier. A UE can know that a corresponding downlink grant relates to what component carrier through the carrier indicator. For example, if the second downlink control information includes a carrier indicator indicative of a second SCC, the format indicator include in the second downlink control information indicates the format of the control channel of the second SCC.

The BS 701 transmits the configured first downlink control information to the UE 700 through a PDCCH1, that is, a physical control channel, and transmits the configured second downlink control information to the UE 700 through a PDCCH2, that is, a physical control channel (S710). For example, the PDCCH1 and the PDCCH2 may be transmitted on the same component carrier, for example, on a PCC. For another example, the PDCCH1 and the PDCCH2 may be transmitted on different component carriers. For example, the PDCCH1 may be transmitted on a first component carrier (or a PCC), and the PDCCH2 may be transmitted on a second component carrier (or an SCC).

The UE 700 sets transmit power for a PUCCH based on the power indicator and decodes a PCFICH, a PDCCH, and a PDSCH based on the format indicator (S715). The decoding of the PDCCH is performed by blind decoding. Blind decoding is a method of defining a specific decoding start point in the region of a predetermined PDCCH, performing decoding on all possible DCI format in given transmission mode, and identifying a user based on C-RNTI information masked to CRC.

The UE 700 transmits uplink control information to the BS 701 through an uplink control channel that is configured based on the first and the second downlink control information (S720). The uplink control channel may be configured on the primary component uplink carrier linked to the primary component downlink carrier.

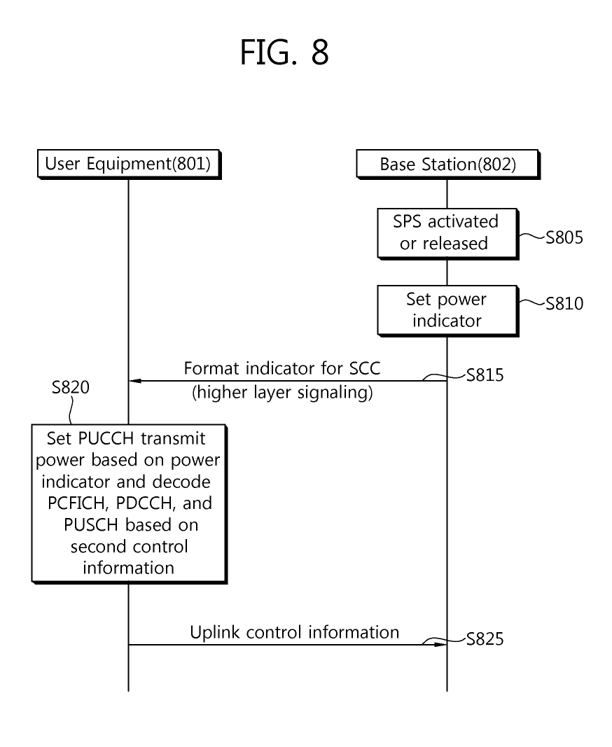

FIG. 8 is a flowchart illustrating a method of transmitting control information in a multi-component carrier system in accordance with another example of the present invention. This corresponds to a case where communication is performed by Semi-Persistent Scheduling (SPS).

Referring to FIG. 8, a BS 802 indicates the activation or release of SPS (S805). The SPS means a method of maintaining uplink or downlink communication without an additional PDCCH by fixedly allocating SPS during a specific period. The activation and release of SPS are performed by setting the field of a PDCCH in a specific condition. In relation to this setting, a power indicator field may be matched with a specific value. In this case, the PDCCH is configured using a conventional method because the power indicator field cannot be used as a format indicator. DCI formats when SPS is activated are set as in Table 4.

TABLE 4

| | DCI format 0 | DCI format 1/1A | DCI format 2/2A/2B/2C |
|---|---|---|---|
| TPC command for scheduled | Set to 00 | N/A | N/A |
| PUSCH | | | |
| Cyclic shift of a DMRS | Set to 000 | N/A | N/A |
| Modulation and coding | Most significant | N/A | N/A |
| scheme/redundancy version | bit (MSB) is set | | |
| | to 0 | | |
| HARQ process number | N/A | FDD: set to 000, | FDD: set to 000, TDD: set |
| | | TDD: set to 0000 | to 0000 |
| Modulation and coding | N/A | MSB is set to 0 | MSB is set to 0 for an |
| scheme | | | enabled transport block |
| Redundancy version | N/A | Set to 00 | MSB is set to 00 for an |
| | | | enabled transport block |

DC formats when SPS is released are set as in Table 5.

TABLE 5

| | DCI format 0 | DCI format 1A |
|---|---|---|
| TPC command for scheduled PUSCH | Set to 00 | N/A |
| Cyclic shift of a DMRS | Set to 000 | N/A |
| Modulation and coding scheme/ | Set to 11111 | N/A |
| redundancy version | | |
| Resource block allocation and | All set to 1 | N/A |
| hopping resource allocation | | |
| HARQ process number | N/A | FDD: set to 000, |
| | | TDD: set to 000 |
| Modulation and coding scheme | N/A | Set to 11111 |
| Redundancy version | N/A | Set to 00 |
| resource block allocation | N/A | All set to 1 |

The value of the power indicator for the PUCCH when SPS is activated or released is as in Table 6.

TABLE 6

| Value of | |
|---|---|
| TPC | |
| command | |
| for | |
| PUCCH | n^{(L,p)}_{PUCCH} |
| 00 | First PUCCH resource index configured by a higher layer |
| 01 | Second PUCCH resource index configured by a higher layer |
| 10 | Third PUCCH resource index configured by a higher layer |
| 11 | Fourth PUCCH resource index configured by a higher layer |

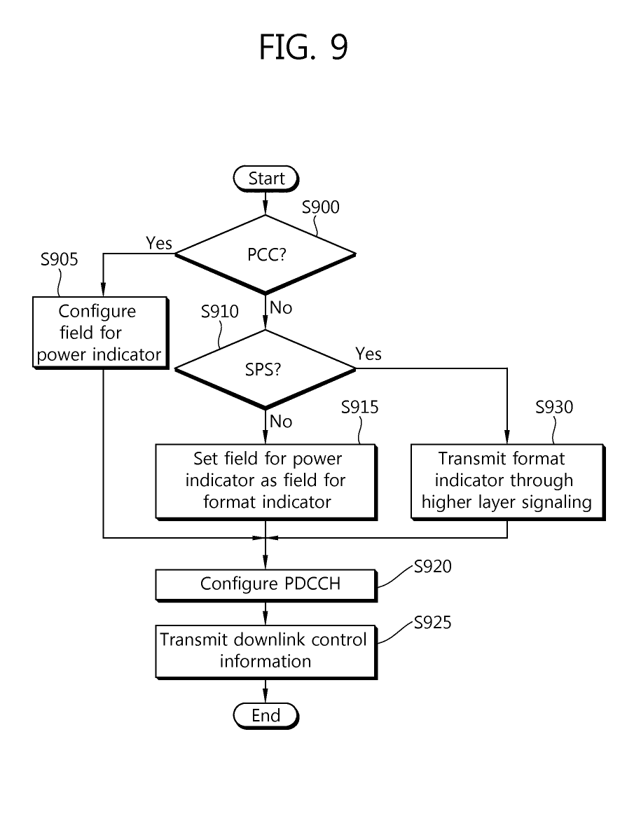

FIG. 9 is a flowchart illustrating a method of transmitting control information in a multi-component carrier system in accordance with an example of the present invention.

Referring to FIG. 9, a BS determines whether a target carrier to be transmitted by the BS is a PCC or an SCC (S900). If the target carrier is a PCC, the BS sets a power indicator field, included in downlink control information, as a proper power indicator (S905).

Furthermore, the BS configures a PDCCH as the downlink control information including the set power indicator (S920) and transmits the downlink control information to a UE through the configured PDCCH (S925).

If the target carrier is not the PCC, but the SCC at step S900, the BS determines whether SPS has been applied for the UE (S910). If scheduling has been performed by SPS for the UE, the BS sets a field for a power indicator as a field for a format indicator (S915). That is, the number of OFDM symbols that configures a PDCCH regarding the SCC is inputted as the field for the power indicator. The BS configures a PDCCH based on the downlink control information including the set format indicator (S920) and transmits the downlink control information to the UE through the configured PDCCH (S925).

If scheduling has not been performed by SPS for the UE at step S910, the BS transmits the format indicator to the UE through signaling of a higher layer, such as an MAC layer or an RRC layer (S930). This step is an optional step, and the BS may not take a special procedure. In this case, the format indicator regarding the SCC is not transmitted through the PCC, but is still transmitted through the PCFICH of the SCC. The BS configures a PDCCH based on the downlink control information (S920) and transmits the downlink control information to the UE through the configured PDCCH (S925).

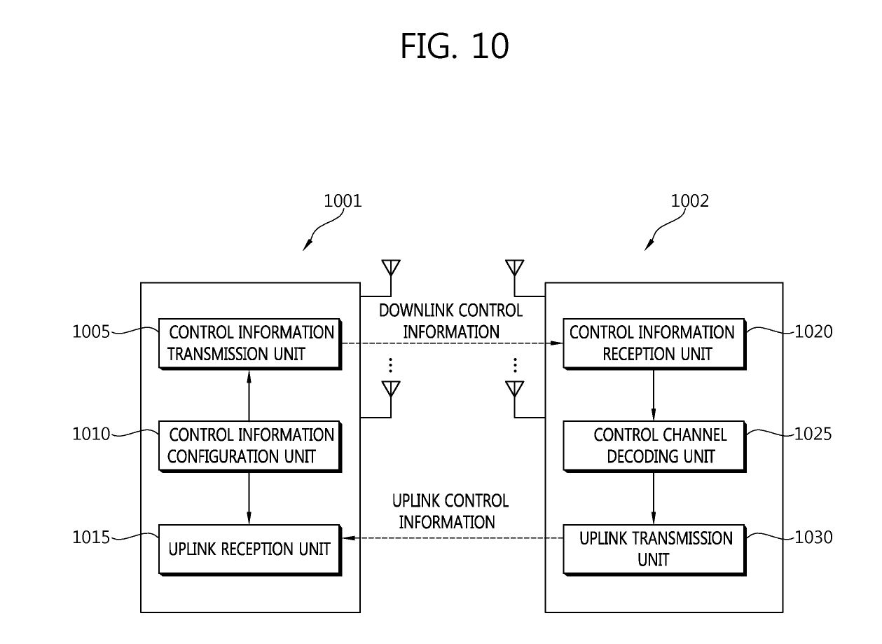

FIG. 10 is a block diagram illustrating an apparatus for transmitting and receiving control information in a multi-component carrier system in accordance with an example of the present invention.

Referring to FIG. 10, the apparatus 1001 for transmitting the control information includes a control information transmission unit 1005, a control information configuration unit 1010, and an uplink reception unit 1015.

The control information configuration unit 1010 configures first downlink control information including a power indicator and second downlink control information including a format indicator. The power indicator indicates the transmit power of an uplink control channel, and the format indicator indicates the format of the control region of a specific component carrier. For example, in cross-carrier scheduling, the format indicator indicates the number of OFDM symbols for the PDCCH of a secondary component downlink carrier. The power indicator and the format indicator have the same length of an information bit and may have the same format. This is only an example, and the length of the information bit and the format may be different. The first downlink control information can further include resource allocation information on the PDSCH1, and the second downlink control information can further include resource allocation information on the PDSCH2.

Furthermore, each of the first and the second downlink control information can further include a Carrier Indicator (CI) indicating a component carrier.

The control information transmission unit 1005 transmits the first downlink control information to an apparatus 1002 for receiving control information through the PDCCH1, that is, a physical control channel and transmits the second downlink control information to the apparatus 1002 for receiving control information through the PDCCH2, that is, a physical control channel. For example, in the case of cross-carrier scheduling, both the PDCCH1 and the PDCCH2 may be transmitted on the same component carrier, for example, a PCC. For another example, the PDCCH1 and the PDCCH2 may be transmitted on different component carriers. For example, the PDCCH1 may be transmitted on a first component carrier (or PCC), and the PDCCH2 may be transmitted on a second component carrier (or SCC).

The uplink reception unit 1015 receives uplink control information from the apparatus 1002 for receiving control information through the uplink control channel that is configured based on the first and the second downlink control information.

The apparatus 1002 for receiving the control information includes a control information reception unit 1020, a control channel decoding unit 1025, and an uplink transmission unit 1030.

The control information reception unit 1020 receives the PDCCH1 and the PDCCH2 from the apparatus 1001 for transmitting control information.

The control channel decoding unit 1025 extracts first downlink control information by decoding the PDCCH1 and obtains a power indicator regarding an uplink control channel and resource allocation information on the PDSCH1 from the first downlink control information. The control channel decoding unit 1025 extracts second downlink control information by decoding the PDCCH2 and obtains a format indicator regarding a specific component carrier and resource allocation information on the PDSCH2 of the specific component carrier from the second downlink control information. Here, in the case of cross-carrier scheduling, the PDSCH1 may be transmitted on a PCC, and the PDSCH2 may be transmitted on an SCC.

The control channel decoding unit 1025 decodes the PCFICH and the PDSCH2 of a specific component carrier based on the obtained format indicator.

The uplink transmission unit 1030 transmits the uplink control channel regarding the PDSCH1 or the PDSCH2 with power according to the power indicator.

The above description is only an example of the technical spirit of the present invention, and those skilled in the art may change and modify the present invention in various ways without departing from the intrinsic characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or is variations induced from the meaning and scope of the appended claims and their equivalents.

1. A method of a base station transmitting control information in a multi-component carrier system in which a primary component carrier and a secondary component carrier are aggregated, the method comprising the steps of:
configuring downlink control information (DL grant) comprising a format indicator indicative of a number of Orthogonal Frequency Division Multiplexing (OFDM) symbols for a control region;
configuring the control region according to the number of OFDM symbols;
transmitting a physical downlink control channel (hereinafter referred to as a PDCCH) comprising the configured downlink control information; and
transmitting a physical control format indicator channel (hereinafter referred to as a PCFICH), comprising the format indicator, on the control region.

2. The method of claim 1, further comprising the step of receiving uplink control information from a user equipment through an uplink control channel configured based on the downlink control information.

3. The method of claim 2, further comprising the step of receiving downlink control information comprising a power indicator, wherein the power indicator indicates transmit power of the uplink control channel.

4. The method of claim 2, wherein information bits of the format indicator and the power indicator have an identical length.

5. The method of claim 1, wherein:
the PDCCH is transmitted on the primary component carrier,
the control region is a control region of the secondary component carrier, and
the PCFICH is transmitted on the secondary component carrier.

6. A method of a user equipment receiving control information in a multi-component carrier system in which a primary component carrier and a secondary component carrier are aggregated, the method comprising the steps of:
receiving first downlink control information, comprising a format indicator indicative of a number of Orthogonal Frequency Division Multiplexing (OFDM) symbols that form a control region, from a base station through a first physical downlink control channel (PDCCH); and
transmitting uplink control information to the base station through a physical uplink control channel (PUCCH).

7. The method of claim 6, wherein:
the first PDCCH is transmitted on the primary component carrier, and
the control region is a control region of the secondary component carrier.

8. The method of claim 7, further comprising the step of receiving second downlink control information comprising a power indicator from the base station through a second PDCCH of the primary component downlink carrier, wherein the power indicator indicates transmit power of the PUCCH.

9. An apparatus for receiving control information in a multi-component carrier system in which a primary component carrier and a secondary component carrier are aggregated, the apparatus comprising:
a control information reception unit for receiving first downlink control information, comprising a format indicator indicative of a number of OFDM symbols for a control region, through a first PDCCH and receiving second downlink control information, comprising a power indicator for controlling transmit power of an uplink control channel, through a second PDCCH;
a control channel decoding unit for decoding a physical control format indicator channel (PCFICH) and a physical downlink shared channel (PDSCH) indicated by the first PDCCH based on the format indicator; and
an uplink transmission unit for controlling transmit power of a uplink control channel regarding the PDSCH based on the power indicator and transmitting the uplink control channel.

10. The apparatus of claim 9, wherein the control information reception unit receives the first PDCCH and the second PDCCH on the primary component carrier.

11. The apparatus of claim 9, wherein the control information reception unit receives the first PDCCH on the secondary component carrier and receives the second PDCCH on the primary component carrier.

12. An apparatus for transmitting control information in a multi-component carrier system in which a primary component carrier and a secondary component carrier are aggregated, the apparatus comprising:
a control information configuration unit for configuring first downlink control information, comprising a format indicator indicative of a number of Orthogonal Frequency Division Multiplexing (OFDM) symbols for a control region, and second downlink control information comprising a power indicator for controlling transmit power of an uplink control channel;
a control information transmission unit for transmitting the first downlink control information through a first physical downlink control channel (PDCCH) and transmitting the second downlink control information through a second PDCCH; and
an uplink reception unit for receiving an uplink control channel transmitted at transmit power based on the power indicator related to a physical downlink shared channel (PDSCH) indicated by the first PDCCH.

13. The apparatus of claim 12, wherein the control information transmission unit transmits the first PDCCH and the second PDCCH on the primary component carrier.

14. The apparatus of claim 12, wherein the control region includes 2 or 3 OFDM symbols.
